(19) United States
(12) Patent Application Publication
(10) Pub. No.: US 2015/0143656 A1
(43) Pub. Date: May 28, 2015

(54) WIPER BLADE DEVICE

(71) Applicant: Robert Bosch GmbH, Stuttgart (DE)

(72) Inventor: Helmut Depondt, Boutersem (BE)

(73) Assignee: Robert Bosch GmbH, Stuttgart (DE)

(21) Appl. No.: 14/404,886

(22) PCT Filed: May 27, 2013
(86) PCT No.: PCT/EP2013/060828

§ 371 Date: Dec. 1, 2014

(30) Foreign Application Priority Data
Jun. 1, 2012 (DE) 102012209304.4

(51) Int. Cl. B60S 1/38

(52) U.S. Cl. CPC B60S 1/3882; B60S 1/3875; B60S 2001/3898
USPC 15/250.48; 29/428

(57) ABSTRACT

The invention relates to a wiper blade device (10) comprising at least one spring strip (12) and at least one wiper strip (20). According to the invention, said spring strip (12) comprises at least one first holding claw (14) for securing the wiper strip unit (20).

### BACKGROUND OF THE INVENTION

Wiper blade devices according to the prior art comprise at least one spring strip and at least one wiper strip unit.

### SUMMARY OF THE INVENTION

The invention relates to a wiper blade device comprising at least one spring strip and at least one wiper strip unit. By the term “spring strip”, a macroscopic element is particularly to be understood which comprises at least one extension which, in a normal operating state, can be elastically changed by at least 10%, in particular by at least 20%, preferably by at least 30% and especially advantageously by at least 50% and which particularly generates a counter force which is dependent on a change of the extension and is preferably proportional to the change. In so doing, the counter force counteracts the change. By the term “extension” of an element, a maximum distance between two points of a perpendicular projection of the element onto a plane is to be understood. The term “macroscopic element” refers particularly to an element having an extension of at least 1 mm, in particular of at least 5 mm and preferably of at least 10 mm. The spring strip preferably consists at least partially of spring steel. In an unloaded state, the spring strip preferably has substantially a shape of a bent bar and particularly advantageously of a flattened, bent bar. It is particularly advantageous if a curvature of the spring strip along a longitudinal extension in an unloaded state is greater than a curvature of a vehicle surface of a motor vehicle, in particular a vehicle window pane, across which the spring strip is passed in at least one operating state. A “wiper strip unit” refers particularly to a unit made from an elastic material and comprising a wiper lip, which is provided for cleaning a surface to be cleaned, in particular a window pane surface, preferably a window pane surface of a motor vehicle, by being moved across the surface to be cleaned while maintaining contact with said surface. The wiper strip unit is preferably manufactured from a natural or artificial elastomer, in particular rubber.

According to the invention, the spring strip comprises at least one first holding claw for securing the wiper strip unit. By the term “holding claw”, an element is particularly to be understood which is provided to grip below an element to be supported from a side, preferably at a holding region which is specially provided for this purpose, and which comprises a supporting region for securing the element to be supported in a load-bearing manner. By the phrase “gripping below from a side”, it is to be understood that the spring strip is disposed above the wiper strip unit in an installed state of the wiper blade device, in which the wiper blade device is mounted in a windshield wiper. It is further to be understood that the support region of the holding claw is disposed below the holding region of the wiper strip unit and is oriented so as to align orthogonally to a main extension direction of the wiper strip unit. An “orientation of the support region” is particularly to be understood as an extension of the support region originating at a connecting part of the holding claw to a main body of the spring strip. Connecting part and support region are preferably designed perpendicularly to one another. By means of the inventive design of the wiper blade device, a reliable fastening of the wiper strip unit to the spring strip and an assembly of said unit to the spring strip which is easily carried out can be achieved.

According to the invention, the holding claw is furthermore integrally formed with the spring strip. The term “integrally” refers to being connected at least in a materially bonded manner, for example by means of a welding process, an adhesive bonding process, an injection molding process and/or another process that seems useful to the person skilled in the art and/or advantageously to be formed in a single piece, such as, for example, by means of being cast in one piece and/or by means of a production by single- or multi-component injection molding, and advantageously from a single blank.

The invention furthermore proposes a second holding claw which is disposed in a transverse direction of the spring strip so as to lie opposite to the first holding claw. By the term “transverse direction”, a direction is to be understood which extends at least substantially orthogonally to the main extension direction. By the phrase “at least substantially orthogonally”, it is particularly to be understood that an angle between the transverse direction and the main extension direction deviates at a maximum by five degrees, advantageously at a maximum of two degrees and preferably at a maximum of one degree. A “main extension direction” of the spring strip refers particularly to a direction of the longest extension of the spring strip. In principle, the wiper blade device can comprise a plurality of holding claws, wherein two holding claws are preferably disposed in each case opposite to one another. In particular, the wiper strip unit can thereby be fastened to the spring strip with a high degree of stability and security from slippage.

According to the invention, the holding claws further form a receiving channel extending in the main extension direction of the spring strip. By the term “receiving channel”, an open space extending along the main extension direction of the spring strip is to be understood which, parallel to the transverse direction of the spring strip, is at least partially delimited by the holding claws and parallel to the main extension direction of the spring strip by the main body of the spring strip and the holding claws. “At least partially delimited” refers particularly to the fact that holding claws are disposed parallel to the transverse direction of the spring strip at least at both end regions of the receiving channel, said holding claws extending parallel to the transverse direction and to the main extension direction of the spring strip. The holding claws preferably extend parallel to the main extension direction of the spring strip along an entire longitudinal extension of the receiving channel. The support regions of the holding claws preferably extend across at least twenty percent of a transverse expansion of the receiving channel. Hence, the wiper strip unit can particularly be fastened to the spring strip in a highly reliable manner; and the wiper strip unit can be mounted to the spring strip in a manner that can be easily performed.

According to the invention, the wiper strip unit is further designed as a multi-component part. A “wiper strip unit designed as a multi-component part” is particularly to be understood as a wiper strip unit which comprises at least two sections having differing material properties, for example with regard to stiffness or material hardness. The wiper strip unit designed as a multi-component part can have basically been manufactured from two individually manufactured elements which are different with regard to the material properties thereof and were joined to one another in a materially bonded manner; or said wiper strip unit can be manufactured as a single piece, wherein a region was selectively changed in the material properties thereof by means of an added material or a treatment, for example a hardener for stiffening purposes or irradiation by means of a particle beam for forming cross links. By designing the wiper strip unit as a multi-component part, an advantageous adjusting of regions of the wiper strip unit to different requirement profiles can particularly be achieved, and a wiping performance of the wiper strip unit can be improved.

The invention furthermore proposes that the wiper strip unit has at least one reinforced head region. By the term “reinforced head region”, a head region is to be understood which has a stiffness that is at least five percent, advantageously at least ten percent and preferably at least twenty percent higher than a stiffness of a further region of the wiper strip unit, in particular a wiper lip. A reinforced head region is particularly achieved by the head region being manufactured from a material, preferably an elastomer, having a greater stiffness than a material of the remaining regions of the wiper strip unit. In principle, head region and remaining regions of the wiper strip unit can also be manufactured from a single material, wherein the head region has been subjected to a treatment for increasing stiffness, for example to the addition of material hardeners or to an irradiation for forming stronger cross links. A “head region” refers particularly to a region of the wiper strip unit that faces away from the wiper lip. The wiper lip unit is preferably fastened to the spring strip via the head region. As a result, a robust wiper lip unit can namely be achieved.

According to the invention, the spring strip is furthermore designed as a stamped part and/or as a bent sheet metal part. A spring strip can particularly be produced in a process that is easy to carry out.

The invention furthermore describes a method for mounting a wiper blade device, in which the wiper strip unit is mounted to the spring strip in a procedural step comprising a mounting movement that takes place in the main extension direction of the spring strip.

### BRIEF DESCRIPTION OF THE DRAWINGS

Further advantages ensue from the following description of the drawings. An exemplary embodiment of the invention is depicted in the drawings. The drawings, the description and the claims contain numerous features in combination. The person skilled in the art will also expediently consider the features in isolation and put them together to form further useful combinations.

In the drawings:

FIG. 1 shows a wiper blade comprising a wiper blade device according to the invention;

FIG. 2 shows the wiper blade device in an uninstalled state and

FIG. 3 shows the wiper blade device in an installed state in a cross-sectional view.

### DETAILED DESCRIPTION

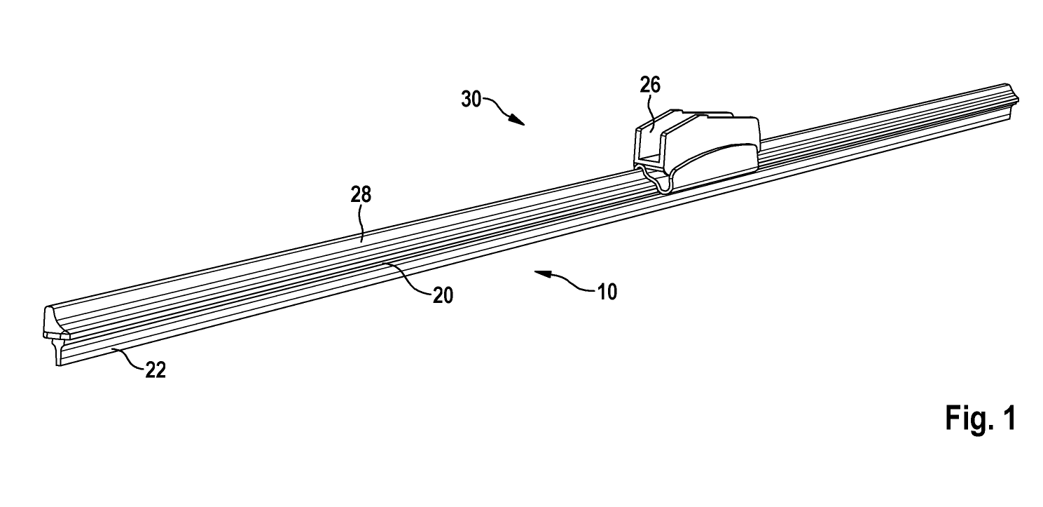

FIG. 1 shows a wiper blade 30 of a motor vehicle windshield wiper including an inventive wiper blade device 10 which comprises at least one spring strip 12 and at least one wiper strip unit 20 that has a wiper lip 22. The wiper lip 22 is provided to be moved across a window pane of a motor vehicle to be cleaned while maintaining contact with said window pane, and, in so doing, to remove contaminants from the same. A wiper fluid can further be employed to ease the removal of the contaminants. The wiper blade 30 has a wiper spoiler 28 which is provided to prevent the wiper blade 20 from being excessively rinsed by the wiper fluid. The wiper spoiler 28 is further provided to deflect an airstream acting on the wiper blade device and to press the wiper lip 22 against the window pane. The wiper blade 30 further comprises a wiper blade adapter 26 for coupling to a wiper arm of the motor vehicle's windshield wiper.

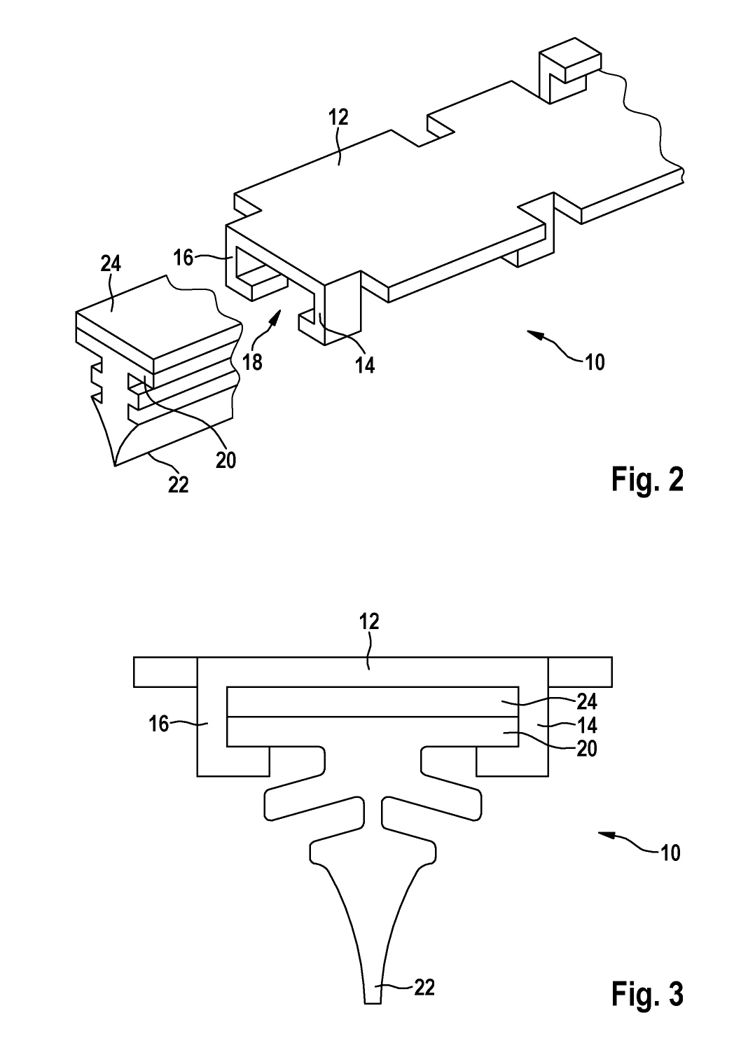

The spring strip 12 of the wiper blade device 10 comprises a first holding claw 14 (FIG. 2) for securing the wiper strip unit 20 and a second holding claw 16 which is disposed in a transverse direction 46 of the spring strip 12 so as to lie opposite to the first holding claw 14. The first holding claw 14 and the second holding claw 16 are formed integrally with the spring strip 12 and manufactured in one piece with a main body 48 of the spring strip 12, said main body being formed from a substantially rectangular, planar body. The first holding claw 14 comprises a connecting part 32 that protrudes perpendicularly from the main body 48 and a support region 36 that protrudes perpendicularly from the connecting part 32, extends parallel to the main body 48 of the spring strip 12 and is covered in a projection of the main body 48. The second holding claw 16 comprises a connecting part 34 and a support region 38 analogous to the first holding claw 14. The spring strip 12 is designed as a stamped sheet metal part. In an alternative or additional embodiment, the spring strip can be designed as a bent sheet metal part.

The holding claws 14, 16 form a receiving channel 18 extending in a main extension direction 44 of the spring strip 12. The receiving channel 18 is delimited parallel to the transverse direction 46 of the spring strip 12 by the holding claws 14, 16 and in particular by connecting parts 32, 34 of the holding claws 14, 16. The receiving channel 18 is partially delimited parallel to the main extension direction 44 of the spring strip 12 on a side facing away from the main body 48 of the spring strip 12 by the support regions 36, 38. In so doing, a clearance is formed between the support regions 36, 38.

The wiper strip unit 20 is designed as a multi-component part and comprises a reinforced head region 24. The reinforced head region 24 is manufactured from an elastomer material which has a ten percent higher stiffness than an elastomer material from which the remaining regions of the wiper strip unit 20 are manufactured. The reinforced head region 24 is provided for introducing the wiper strip unit 20 into the receiving channel 18 of the wiper blade device 10 and comprises two lateral holding regions 40, 42 which bear on the support regions 36, 38 of the holding claws 14, 16 in an installed state (FIG. 3) of the wiper blade device 10.

In a method for installing the wiper blade device 10, the wiper strip unit 20 is mounted to the spring strip 12 by means of a mounting movement taking place in the main extension direction 44 of the spring strip 12. In this mounting movement, the reinforced head region 24 is introduced into the receiving channel 18, wherein the holding regions 40, 42 are placed onto the support regions 36, 38.

1. A wiper blade device comprising at least one spring strip (12) and at least one wiper strip unit (20), characterized in that the spring strip (12) comprises at least one first holding claw (14) for securing the wiper strip unit (20).

2. The wiper blade device according to claim 1, characterized in that the first holding claw (14) is formed integrally with the spring strip (12).

3. The wiper blade device according to claim 1, characterized by at least one second holding claw (16) which is disposed in a transverse direction (46) of the spring strip (12) so as to lie opposite to the first holding claw (14).

4. The wiper blade device according to claim 3, characterized in that the first and second holding claws (14, 16) form a receiving channel (18) which extends in a main extension direction (44) of the spring strip (12).

5. The wiper blade device according to claim 1, characterized in that the wiper strip unit (20) is designed as a multi-component part.

6. The wiper blade device according to claim 1, characterized in that the wiper strip unit (20) has at least one reinforced head region (24).

7. The wiper blade device according to claim 1, characterized in that the spring strip (12) is designed as a stamped and/or bent sheet metal part.

8. (canceled)

9. (canceled)

10. A wiper blade comprising a wiper blade device (10) according to claim 1.

11. A method for installing a wiper blade device (10) according to claim 1, comprising mounting the wiper strip unit (20) to the spring strip (12) in a procedural step comprising a mounting movement that takes place in the main extension direction (44) of the spring strip (12).

12. The wiper blade device according to claim 6, wherein the reinforced head region is made of an elastomer material which has a ten percent higher stiffness than an elastomer material from which the remaining regions of the wiper strip unit are made.

13. The wiper blade device according to claim 6, wherein the first and second holding claws (14, 16) form a receiving channel (18) which extends in a main extension direction (44) of the spring strip (12), and wherein the reinforced head region is configured to introduce the wiper strip unit into the receiving channel and comprises two lateral holding regions (40, 42) which bear on the holding claws in an installed state of the wiper blade device.

14. The wiper blade device according to claim 2, characterized by at least one second holding claw (16) which is disposed in a transverse direction (46) of the spring strip (12) so as to lie opposite to the first holding claw (14).

15. The wiper blade device according to claim 14, characterized in that the first and second holding claws (14, 16) form a receiving channel (18) which extends in a main extension direction (44) of the spring strip (12).

16. The wiper blade device according to claim 15, characterized in that the wiper strip unit (20) is a multi-component part.

17. The wiper blade device according to claim 16, characterized in that the wiper strip unit (20) has at least one reinforced head region (24).

18. The wiper blade device according to claim 17, characterized in that the spring strip (12) is a stamped and/or bent sheet metal part.

19. The wiper blade device according to claim 18, wherein the reinforced head region is made of an elastomer material which has a ten percent higher stiffness than an elastomer material from which the remaining regions of the wiper strip unit are made.

20. The wiper blade device according to claim 19, wherein the first and second holding claws (14, 16) form a receiving channel (18) which extends in a main extension direction (44) of the spring strip (12), and wherein the reinforced head region is configured to introduce the wiper strip unit into the receiving channel and comprises two lateral holding regions (40, 42) which bear on the holding claws in an installed state of the wiper blade device.
